(19) United States
(12) Patent Application Publication
(10) Pub. No.: US 2011/0051606 A1
(43) Pub. Date: Mar. 3, 2011

(54) Method, System and Apparatus for Efficient Packet Analysis

(75) Inventors: Zachary Cutlip, Silver Spring, MD (US); Lewis R. Raszewski, Baltimore, MD (US); Charles D. Sellers, Columbia, MD (US)

(73) Assignee: Tresys Technology, LLC, Columbia, MD (US)

(21) Appl. No.: 12/550,049

(22) Filed: Aug. 28, 2009

(51) Int. Cl. H04L 12/26; H04L 12/56

(52) U.S. Cl. 370/252; 370/401

(57) ABSTRACT

A system, method, and apparatus that efficiently and stringently analyze messages are provided. A message's properties are encoded into a bitwise representation of fixed length, which is compared to a binary representation of each rule from a release policy to determine if the rule is satisfied. This process is efficient and allows near real time comparisons and decisions.

### BACKGROUND

1. Field of the Invention

The present invention is generally directed to secured messaging systems and methods, and more particularly to secured messaging systems and methods utilizing efficient packet analysis.

2. Related Art

Message-oriented middleware is used to evaluate messages passing to and from different networks and to pass messages that meet certain criteria. One example of message-oriented middleware is Java Message System (JMS). JMS achieves loose architectural coupling through the use of two separate interaction models: publish/subscribe and point-to point.

Under a publish/subscribe model, producer applications publish messages to “topics,” and subscriber applications register to receive messages to a “topic.” Producers and subscribers are not directly aware of one another. There can be multiple producers and subscribers for each topic.

Under a point-to-point model, producers post messages to a queue from which a consumer reads. Applications are not directly aware of one another. There can be one or more producers and one or more consumers at a time.

In addition to the producer and consumer applications mentioned above, JMS deployments typically include a JMS Enterprise Message Server. The server hosts the topics or queues and serves as an intermediary between the client applications. Together, the client applications and servers form a JMS fabric. In general, messages are allowed to flow freely between producers and consumers connected to the same JMS fabric. In many ways, this free flow of information is the goal of message-oriented middleware resulting in convenience and flexibility.

Most JMS implementations include access control mechanisms; however, they are not intended to provide stringent separation and control of message passing. Existing solutions check each JMS property individually in the message format, resulting in very poor performance. On average, they process seven (7) messages per second. This is inadequate for situations wherein the timeliness of message analysis is critical because information in messages quickly becomes out of date unless messages are analyzed and passed to a recipient quickly.

Accordingly, what is needed are a system, method, and apparatus that are able to more efficiently and stringently analyze messages.

### SUMMARY

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

A method, system, and apparatus operable to efficiently analyze messages are provided. Messages are released to the recipient or dropped based on values of metadata properties in the message. A release decision is rendered in nearly constant time with respect to the number and complexity of the properties in the message.

An exemplary embodiment includes a rules language, a rules compiler, a properties encoding mechanism, and a decision engine. A user defines a grammar using the rules language, specifying the message properties that should be evaluated. The user also creates a release policy, which defines one or more rules that allow a message to be released. A release rule specifies specific values for a specific combination of properties that should be considered sufficient for the message to be passed to a recipient. Properties specified in a particular release rule are a subset of all the properties specified in the grammar.

Using the grammar, the properties encoding mechanism encodes a message's properties into a bitwise representation of fixed length. The policy compiler encodes each rule from the release policy into a binary representation. For a message being evaluated, the decision engine performs a bitwise comparison between the encoded properties of the message and the binary rules to find a match. This binary match is efficient and allows near real time comparisons and decisions.

Further features and advantages of the invention, as well as the structure and operation of various embodiments of the present invention, are described in detail below with reference to the accompanying drawings. The invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated in and constitute part of the specification, illustrate embodiments of the invention and, together with the general description given above and the detailed descriptions of embodiments given below, serve to explain the principles of the present invention. In the drawings:

FIG. 1 illustrates an exemplary embodiment of an implementation of a system according to the present invention.

FIG. 2 illustrates the encoding and evaluation of a message according to an exemplary embodiment.

FIG. 3 illustrates a message routing system consisting of offload engines and a message router.

FIG. 4 illustrates a logical view of a system according to the present invention.

FIG. 5 illustrates the flow of messages in a logical view of a system according to the present invention.

FIG. 6 illustrates installation of grammar and release policy files.

FIG. 7 is an exemplary table of operations, opcodes, and binary encodings of opcodes.

FIG. 8 illustrates an example of binary encoding of a rule in a release policy.

FIG. 9 illustrates another example of encoding of a rule in a release policy.

FIG. 10 illustrates another example of encoding of a rule in a release policy.

FIG. 11 illustrates an example of an encoded message with two properties.

FIG. 12 illustrates another example of an encoded message.

Features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Systems, method, apparatuses, and computer program products are provided to efficiently analyze Message Oriented Middleware, such as Java Server Message (JMS) protocol messages. Embodiments described herein are able to process thousands of messages per second.

### 1. System Overview

Hardware and software systems, methods, apparatuses, and computer program products are provided to facilitate secure, bi-directional, cross-domain transfer of messages between two or more networks. The networks may be logically separate networks representing distinct security domains.

The messages transferred between the networks may contain any type of information. In a preferred embodiment, each message analyzed by the system also contains metadata properties and values. A grammar may define possible properties and values that may exist in a message, and a release policy may define the properties and values that must be present in a message for the message to be released.

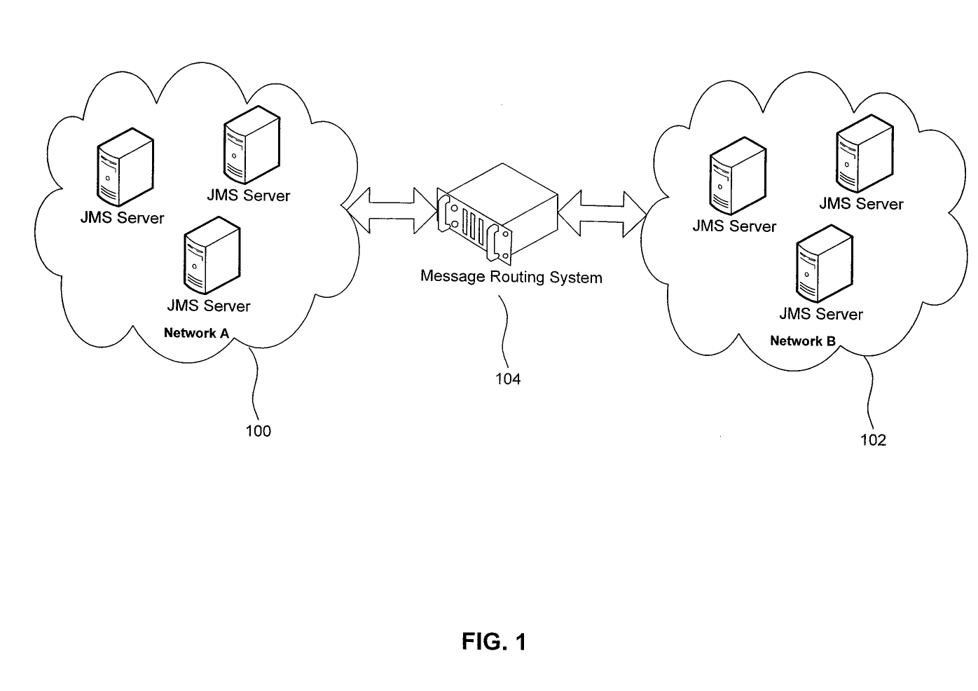

FIG. 1 illustrates an exemplary embodiment of an implementation of an embodiment of a system. Messages are transferred to and from servers operating in a first network 100 and a second network 102 through a message routing system 104. The message routing system 104 analyzes metadata properties and values in each message passing from the first network 100 to the second network 102 or from the second network 102 to the first network 100 and only allows the messages that contain properties and values consistent with the requirements of a release policy to be released to the destination network.

### 1.1 System Components

An exemplary embodiment consists of a rules language that allows a user (such as a system administrator) to define a grammar and a release policy, a rules compiler, a properties encoding mechanism, and a decision engine. In an embodiment, the rules compiler encodes the grammar and release policy into a binary format, and the properties encoding mechanism encodes the messages into a binary format. The decision engine then evaluates the encoded messages against the encoded release policy to determine if the message's properties and values satisfy the rules defined in the release policy.

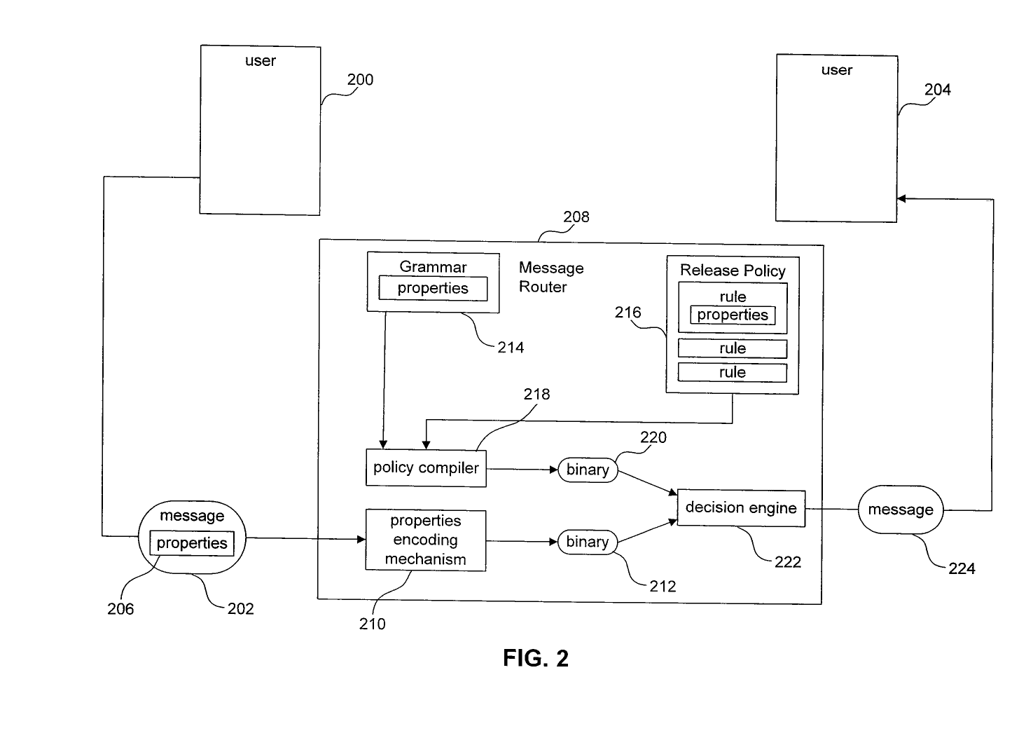

FIG. 2 illustrates the encoding and evaluation of a message according to an exemplary embodiment. In this embodiment, a user 200 sends a message 202 from a first network to a user 204 at a second network. The message 202 may originate from a human user or a device. The message 204 contains metadata properties 206 and values that are evaluated by a message routing system 208. A properties encoding mechanism 210 encodes the message into a binary format 212. A grammar 214 defines the possible properties and values that may be present in a message that are relevant to a release decision, and a release policy 216 defines rules for message evaluation. The properties and values 206 in a message 202 must satisfy at least one rule in the release policy 216 for the message to be released to the recipient user 204.

A policy compiler 218 encodes the grammar 214 and release policy 216 into a binary format 220. The decision engine 222 then analyzes the encoded properties and values of the message 212 and the encoded release policy and grammar 220 to determine if the properties and values 206 in the message 202 satisfy the requirements of at least one rule in the release policy 216. If the properties and values 206 in the message 202 satisfy the requirements of at least one rule in the release policy 216, the message is released 224 to the recipient user 204; otherwise, the message is dropped (i.e., it is not released to the recipient user 204).

### 1.2 Secure Blade System

An exemplary embodiment may be implemented as a secure blade system containing three separate systems, each with its own CPUs, memory, hard drives, and network cards. A system backplane may transfer only power to each system to prevent unintended information flow between the systems.

In one embodiment of a secure blade system, two offload engines (OEs) may be responsible for communicating with message servers on each network and passing messages to a message router. The OEs may be largely similar, and each OE may be responsible for interfacing with the fabric on the network to which it is connected. Applications on each OE may connect to message servers to insert and retrieve messages.

The message router (MR), may be responsible for determining which messages should pass between the two networks. The MR may connect only to the OEs and have no external network connections. The MR may release or deny message passing between the OEs based on the release policy. By default, all messages may be denied release unless specifically permitted by the policy.

In one embodiment of the system, the offload engines may be part of the message router device. For example, the offload engines and message router may be implemented as software on a single device. The offload engine software may be secured so that the offload engine applications do not have access to data executing in another offload engine application. In another embodiment, each offload engine and message router may be implemented as a separate device. Each server sending or receiving a message may be associated with one or multiple offload engines.

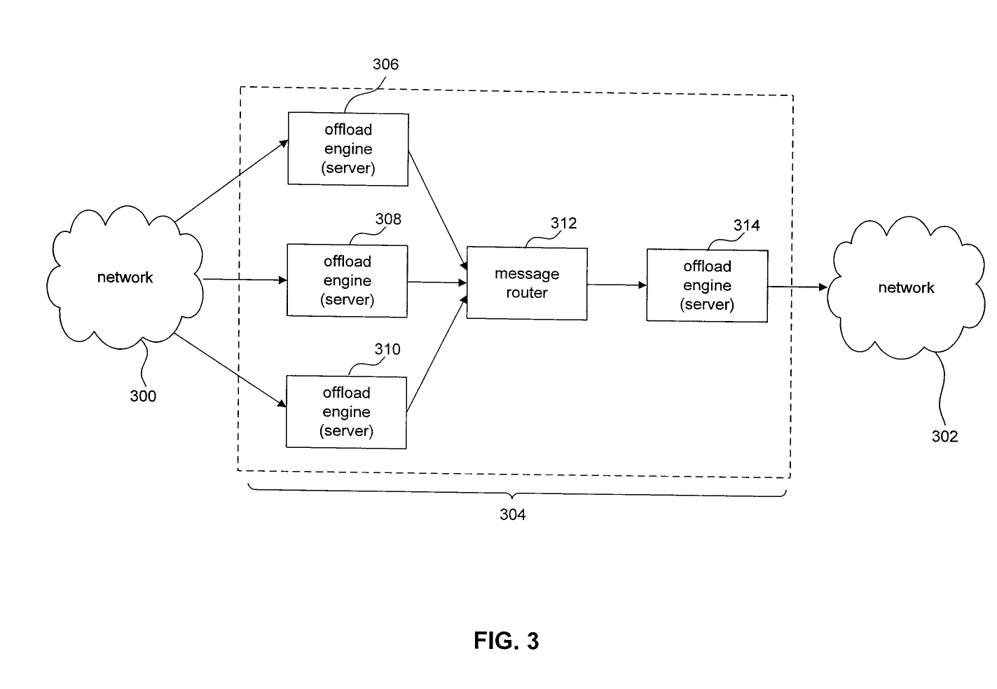

FIG. 3 illustrates a message routing system consisting of offload engines and a message router. A message is sent from a first network 300 to a second network 302 through a message routing system 304. The first network may be associated with a plurality of offload engines 306, 308, and 310, a single offload engine, or no offload engine at all. The offload engines 306, 308, and 310 interface with the fabric of the network 300 and pass the message to the message router 312. The message router evaluates the message, and, if the message satisfies the rules in the release policy, releases the message to an offload engine 314 that interfaces with the fabric of the recipient network 302 and passes the message to the recipient network 302.

### 1.3 Logical View

In a logical view, the system can be viewed as two separate guard applications distributed across three systems. Each guard, which may be referred to as a pipeline, has components on all three systems and is responsible for passing messages in a single direction. The pipelines each have the same components: a Front End, Message Router, and a Back End.

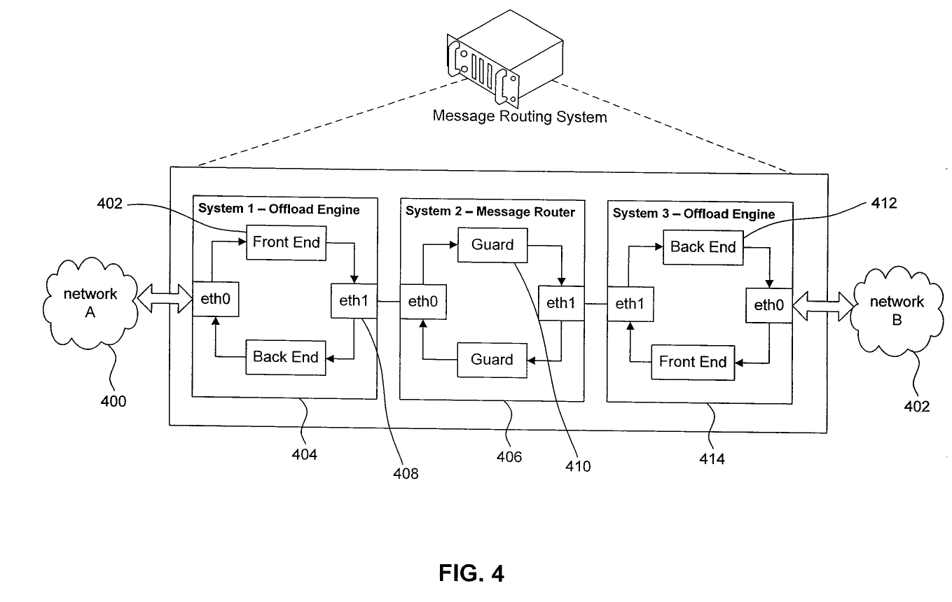

FIG. 4 illustrates a logical view of an embodiment of the system. Messages are held in a queue on a network 400. The Front End component 402 of an offload engine 404 encodes the message properties and combines these encoded properties with an entire unaltered copy of the message, including the properties, and sends it to the message router 406 (for example, through an ethernet port 408), which determines if the message satisfies rules in the release policy. If the message satisfies the rules in the release policy, the guard component 410 of the message router 406 releases the message to the Back End component 412 of the other offload engine 414. Once the message reaches the Back End component 412, the Back End passes the message to the receiving network 402.

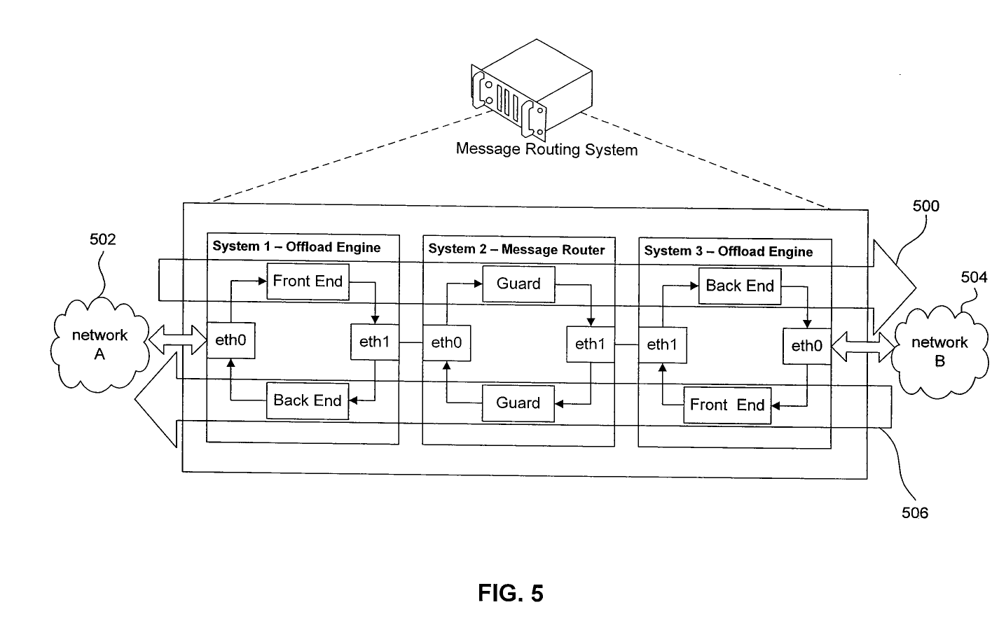

FIG. 5 illustrates the flow of messages in a logical view of the system. Messages passing 500 from a first network 502 to a second network 504 pass 500 through the front end of the offload engine that interfaces with the first network 502 through a guard in the message router and then to the back end of the offload engine that interfaces with the second network 504. Likewise, messages passing 506 from the second network 504 to the first network 502 pass 506 through the front end of the offload engine that interfaces with the second network 504 through a guard in the message router and then to the back end of the offload engine that interfaces with the first network 502.

### 1.4 MOM Embodiments

A preferred embodiment operates using the Java Message System (JMS) protocol. JMS is a message-oriented middleware (MOM) protocol that allows applications to pass messages using a loosely-coupled architecture. Messages in the context of JMS (and in message-oriented middleware in general) are typically small, application-oriented messages. In an exemplary embodiment, the messages are not intended to be directly viewed or created by a user, but rather generated and presented by an application.

Similar embodiments may be implemented using other Message Oriented Middleware protocols, such as Microsoft Message Queuing (MSMQ), Advanced Message Queuing Protocol (AMQP), CORBA, and X400/X5000.

### 2. Grammar and Release Policy

In a preferred embodiment, grammar and release policy files are installed on the message router and offload engines. The grammar may specify which message properties should be examined and the semantics and possible values of those properties, and the release policy may define rules that specify properties and values that must be present in a message for the message to be released.

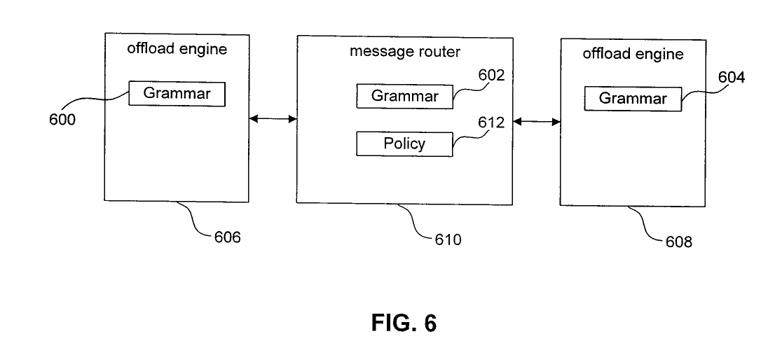

FIG. 6 illustrates installation of grammar and release policy files. In an embodiment, the grammar files (600, 602, and 604) are installed on the offload engines (606 and 608) and the message router 610, while the release policy file(s) 612 are installed on the message router 610 only. In a preferred embodiment, the grammar and release policy files are edited on an external system and installed on each system using a USB device. The grammar and release policy may be text files and may contain XML code.

### 2.1 Grammar

A grammar file may specify which message properties are available for use in decisions made by release policy, how message properties should be interpreted, and what values are allowed for message properties. For example, a message may contain many properties, only a few of which may be relevant to a release decision. Therefore, the grammar may be used to specify which message properties should be considered. A simple example of a grammar file follows:

```
<config identifier=“42”>
      <control name=“Color” type=“String”>
            <value>red</value>
            <value>green</value>
      </control>
      <control name=“releasableTo” type=“Set”>
            <value>US</value>
            <value>UK</value>
      </control>
</config>
```

In this example, the <config> tag is a top-level tag for the file, and the identifier is a unique value for the specific version of the grammar file that is used to verify that the grammar files on the offload engines match the grammar files on the message router. In an embodiment, this identifier is changed to a new value each time the file is edited. Each <control> tag in this example is used to specify a message property to be inspected in the release policy file and how the value of that property should be interpreted. In this case, the first <control> statement describes the property “Color” and specifies that its value should be treated as a string of characters. The <value> tag is used to specify a possible value that is valid for that property. The example above states that the valid values for the “Color” property are “red” and “green.”

The second <control> statement in the example has the “Set” type, which may be a list of strings. For example, if a message property had the value “US UK,” this could be interpreted as the list [“US,” “UK”]. The set type allows the use of additional operators in the rules file. For example, to check that message property “releasableTo” contains at least the value “UK,” the following allow statement could be used:

```
<allow>
      <match name=“releasableTo”>
            <condition value=“UK” operator=“contains” />
      </match>
</allow>
```

This allow statement would match any message with the property “releasableTo” that contained either “UK,” “UK US,” or “US UK.” Many different control data types may be used. Other possible control data types include SensitiveSting and SensitiveSet, which are the same as String and Set, except that comparison operations are sensitive to case.

A <delimiter> tag may be used to indicate characters to be used as set delimiters. A space character may be used as a delimiter between items within as set by default; however, if an item in a set contains a space (for example, “Top Secret”), a delimiter statement may be used to specify an alternative set delimiter.

A grammar may also specify what action should be taken if a message property has a value that is not explicitly listed within the grammar. For example a “special-value” element may be created. The following example grammar illustrates the use of the <delimiter> tag and the “unknown” value:

```
<control name=“Clearance” type=“Set”>
      <value>Top Secret</value>
      <value>Secret</value>
      <value special-value=“unknown” />
      <value>Confidential</value>
      <delimiter>**</delimiter>
</control>
```

A corresponding policy may have the following allow statement:

```
      <allow>
<match name=“Clearance”>
      <condition value=“Confidential**UNKNOWN”
      operator=“containedBy” />
</match>
      </allow>
```

In the above examples, a message would be released if its “clearance” value is “confidential” or any other value not specified in the grammar (in this case, any value besides “Top Secret” and “Secret”). The characters “**” are used as a delimiter to specify different values.

An empty set value may also be specified for the case where a message is received with a blank value. For example, the following grammar fragment defines a “compartment” property with an “empty_set” value:

```
<control name=“compartment” type=“Set”>
      <value>MAGIC</value>
      <value>PURPLE</value>
      <value>empty_set</value>
</control>
```

The following release policy fragment specifies that a message should be released if the “compartment” value is blank:

```
<allow>
      <match name=“compartment”>
            <condition value=“empty_set” operator=“equals” />
      </match>
</allow>
```

A “not” attribute may be used to negate the decision of an operator. For example, the following release policy fragment states that a message will be released if it has no “clearance” value or if its “clearance” value is blank:

```
<allow>
      <match name=“compartment”>
            <condition operator=“contains”
            value=“empty_set MAGIC” />
      </match>
</allow>
```

### 2.2 Release Policy Overview

According to one embodiment, the transfer of messages between networks connected to a message routing system is determined by a configurable message release policy specified by the administrator of the message routing system. Each network may represent a distinct security domain with differing confidentiality or integrity properties. The separation of the networks is maintained by the message routing system, which may determine to release or deny a message based on properties attached to each message, depending on whether the properties satisfy rules defined in the release policy. In an embodiment, the message final release decision is based upon the input and output network, the message properties of each message, and compound comparison operators specified by the administrator.

In an exemplary embodiment, there is no flow of data between the networks except as explicitly allowed by the release policy. The flow of messages may be bidirectional—messages may be sent from or to any network connected to the message routing system. A separate release policy may be defined by the administrator for each direction of message flow. The input and output networks need not be explicitly stated in the release policy; rather, there may be a release policy for each pair of input and output networks.

### 2.3 Routing Configuration

In addition to the release policy, there may be a routing configuration that specifies a mapping between input message resources and output message resources. This routing configuration allows the administrator to specify that messages from a particular resource connected to a first offload engine should be inserted into a particular resource connected to a second offload engine and vice versa. For example, if there is a message queue on Network A named “troop_position” and a message topic on Network B named “current_troop_location,” the routing policy would allow the administrator to specify that releasable messages retrieved from the “troop_position” queue should be inserted into the “current_troop_location” queue. In an exemplary embodiment, the routing configuration does not override the release policy, and a message must be allowed by the release policy and have a valid routing policy in order to be released.

### 2.4 Release Policy Statements

The release policy may contain XML tags that specify conditions to be satisfied for a message to be released. For example, a release policy file may contain the following XML code:

```
<policy>
<target destination=“2”>
<allow>
      <match name=“Color”>
            <condition operator=“equals” value=“red” />
      </match>
</allow>
</target>
</policy>
```

In this example, the <policy> tag is a top-level tag that indicates that the file is a release policy file. The <target> tag specifies the offload engine to which the rules apply (in this case, offload engine 2). The <allow> tag may be used to specify a condition to be met for a message to be released to the target offload engine. In this example, a message is allowed if “Color equals red.” The <match> tag specified a message property to inspect using condition statements. In this example, the property is “Color.” The <condition> tag specifies a condition that must be true for the overall match statement to be true. In a preferred embodiment, each match may have multiple conditions, all of which must be satisfied for the overall match statement to be true.

In this example, the “operator” property of the condition statement determines how the condition is evaluated, and the “value” property specifies the value of the message property used for comparison. In this case, the condition is evaluated by looking for a value of “red” in the Color property of a message. Several different types of operators are possible.

Multiple match statements and multiple allow statements may also be present in a policy. For example, the following XML code contains two allow statements, one of which has two match statements inside:

```
<policy>
<target destination=“2”>
<allow>
      <match name=“Color”>
            <condition operator=“equals” value=“red” />
      </match>
      <match name=“ProjectName”>
            <condition operator=“equals” value=“TurretGate” />
      </match>
</allow>
<allow>
      <match name=“Color”>
            <condition operator=“equals” value=“green” />
      </match>
</allow>
</target>
</policy>
```

In the example above, a message will be release if it contains either: (1) the property “Color” set to “red” and the property “ProjectName” set to “TurretGate” or (2) the property “Color” set to “green.”

Many different operators are also possible. For example, in addition to “equals” and “contains,” other operators may include “exists,” which checks for the existence of a property and “containedBy,” which lists possible strings that input may contain. The operators “less” and “greater” may also be used to define an acceptable subset of a list of property values. For example, a grammar may define the following possible values of the “classification” property:

```
<control name=“classification” type=“String”>
      <value>TS</value>
      <value>S</value>
      <value>U</value>
</control>
```

A release policy may contain the following statement:

```
<allow>
      <match name=“classification”>
            <condition value=“S” operator=“greater” />
      </match>
</allow>
```

In this example, a message will be released if the “classification” is “S” or greater (S or TS) and dropped otherwise (in this case, if the classification is U). If the operator in the above example was “less,” messages with a classification property of S or U would be passed, while those with a classification property of TS would be dropped.

### 2.5 Rules Compiler

The grammar and release policy may be installed on each system using a rules compiler on the message router. In one embodiment, the rules compiler checks the syntax of the grammar and rules and compiled them into a format that may be used to make release policy decisions (for example, binary).

For example, the following command may be used to compile a grammar and release policy (rules):

tg-compiler -g<grammar> -s<rules source> -r<rules output> [--case-insensitive-ok]

In this example, “grammar” is the XML grammar file, “rules source” is the XML source file for the release policy (rules), and “rules output” is the desired path and name of the compiled rules file. To acknowledge the use of case-insensitive types in the grammar, “--case-insensitive-ok” may be used. This option is not required and has no effect if the grammar is purely case sensitive.

### 3. Release Policy and Message Encoding

According to a preferred embodiment, before a message is evaluated, it is first encoded into a binary format. The properties encoding mechanism encodes the metadata in the message (the message properties), and the decision engine evaluates the binary message properties against the release policy compiled by the rules compiler, which is also in a binary format.

### 3.1 Release Policy Encoding

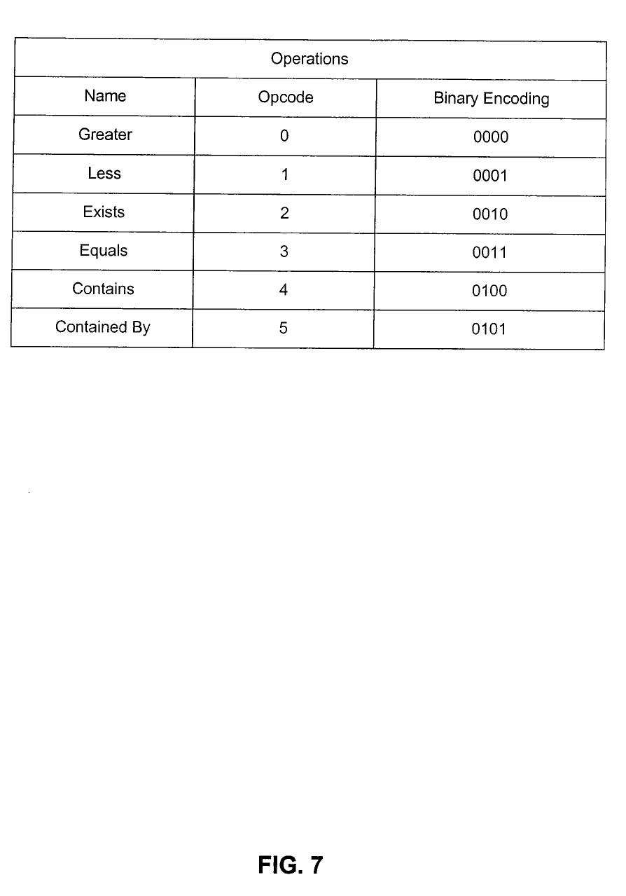

Each rule in the compiled release policy may have an opcode and a rule context for each of its member clauses. In one embodiment, the opcode is non-configurable and corresponds to an operator. FIG. 7 is an exemplary table of operations, opcodes, and binary encodings of opcodes. The following example illustrates an embodiment of release policy encoding:

Grammar Fragment:

```
<control name=“classification” type=“String”>
      <value>TopSecret</value>
      <value>Secret</value>
      <value>Confidential</value>
      <value>Unclassified</value>
</control>
<control name=“category” type=“Set”>
      <value>Purple</value>
      <value>Magic</value>
      <value>Soda</value>
      <value>DVI</value>
</control>
```

Release Policy Fragment:

```
<allow>
      <match name=“classification”>
            <condition value=“Secret” operator=“less” />
      </match>
</allow>
<allow>
      <match name=“classification”>
            <condition value=“Secret” operator=“equals” />
      </match>
      <match name=“category”>
            <condition value=“purple magic”
            operator=“ContainedBy” />
      </match>
</allow>
```

The above example defines a grammar with a “classification” property that has possible values “TopSecret,” “Secret,” “Confidential,” and “Classified” and a “category” property with possible values “Purple,” “Magic,” “Soda,” and “DVI.” The release policy will pass messages with properties that satisfy at least one of two rules: (1) a “classification” less than “Secret” or (2) a “classification” equal to “Secret” and a “category” contained by the set “Purple” and “Magic.”

The first rule has one clause, and the second rule has two clauses. The clause in the first rule has an operation of “less,” which corresponds to opcode “1” with binary encoding “0001” in FIG. 7. The second rule's first clause has an operation of “equals,” which corresponds to opcode “3” with binary encoding “0011” in FIG. 7. The second rule's second clause has an operation of “ContainedBy,” which corresponds to opcode “5” with binary encoding “0101” in FIG. 7.

In a preferred embodiment, each rule context contains a number of bit fields corresponding to the number of properties defined in the grammar. The number of bits in each bit field may be greater than or equal to the number of possible values enumerated in the grammar for a particular message property. Each bit field in the rule context may represent a property value in the corresponding rule. If the value is present in the message, the bit corresponding to the property value is set to 1; otherwise, the bit is set to 0.

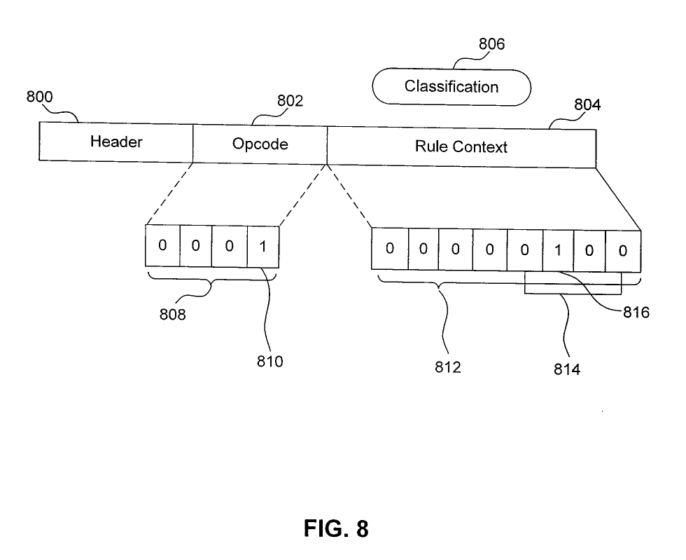

FIG. 8 illustrates an example encoding of a binary encoding of the first rule in the release policy. The encoded rule contains a header 800, an opcode 802, and a rule context 804 that represents a value for a corresponding property in the rule policy (in this case “classification” 806). As shown in FIG. 7, The binary opcode 808 for “less” is “0001.” The rule context 812 contains a number of fields greater than or equal to the number of possible values for the property enumerated in the grammar. In this case, the property “classification” has four possible properties, so any of the last 4 bits 814 may have “1” as a value to denote that the corresponding property is present in a rule. In this example, the rule states that the “classification” must be less than “secret,” which is the second possible value for “classification” listed in the grammar. Therefore, the encoded version of this rule may have the second bit 816 in the set of bits 814 that correspond to the number of possible values for the property “classification.” In one embodiment, the header 800 may contain details necessary for parsing the rest of the rules, such as sizes and offsets of other fields.

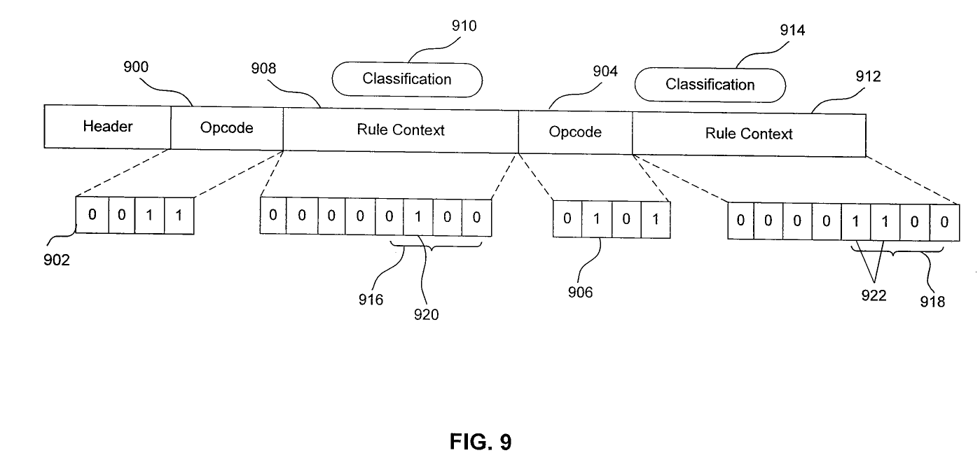

FIG. 9 illustrates the second rule in the release policy. This rule states that a message is released if it has a “classification” equal to “Secret” and a “category” contained by the set “Purple” and “Magic.” As shown in FIG. 7, the binary encoding of the opcode 900 for “equals” is “0011,” 902, and the binary encoding of the opcode 904 for “ContainedBy” is “0101” 906.

In one embodiment, the number and order of the rule context segments in an encoded policy correspond to the number and order of the properties defined in the grammar. For example, if a grammar has three properties (i.e., color, taste, and smell), an encoded policy may contain three rule context segments for each rule—one corresponding to each property defined in the grammar. In this example, two properties are defined: “classification” and “category.” Therefore, the first rule context 908 corresponds to “classification” 910, and the second rule context 912 corresponds to “category” 914. As defined in the grammar, “classification” has four possible values, so any of the last four bits 916 in the corresponding rule context 908 may have the value of “1.” Likewise, “category” also has four possible values, so any of the last four bits 918 in its corresponding rule context 912 may have the value of “1.”

Because this rule states that “classification” must be equal to “Secret” and “Secret” is the second possible value defined in the grammar, the second bit 920 of the four bits 916 representing possible values for “classification” has a value of “1.” Also, because the rule states that “category” must be contained by the set “Purple” and “Magic” and “Purple” and “Magic” are the first and second values, respectively, values in the grammar for “category,” the first and the second bits 922 of the four bits 918 representing possible values for “category” have a value of “1.”

### 3.2 Message Encoding

In a preferred embodiment, each message encoded by the properties encoding mechanism into binary has a header and at least one property. As with encoded policies, each property in the message that is evaluated by the decision may correspond to a property defined in the grammar. In a preferred embodiment, each property that is relevant to a release decision (i.e., each property that is defined in the grammar and used in a rule) will be evaluated in the message. For example, if two properties are defined in the grammar and used in a rule, the presence, absence, or value of those properties will be evaluated in the message. The header may contain sizes, counts, offsets of various fields, and other details used to parse the message.

Messages may also contain properties and values that are not relevant to a release decision. The release policy determines relevant properties. In a preferred embodiment, only the properties used in one or more rules are evaluated by the decision engine, saving time and processing resources.

Each encoded message property may have a bit set to indicate the value present in the message. When the decision evaluates a release decision for each message, the decision engine evaluates the properties of the message against each rule in the release policy until a complete rule is satisfied or until there are no more rules to evaluate.

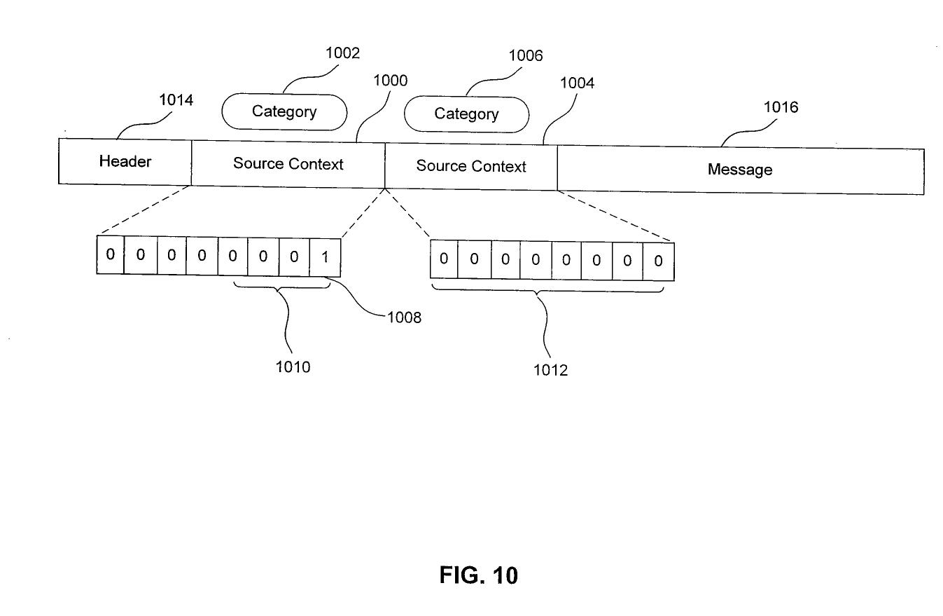

FIG. 10 illustrates an example of an encoded message with a “classification” property set to “unclassified.” Because two properties are defined in the grammar, “classification” and “category,” each message has a first source context 1000 corresponding to “classification” 1002 and a second source context 1004 corresponding to “category” 1006. In this example, the “classification” property of the message is “unclassified,” which corresponds to the fourth possible value for “classification” defined in the grammar. Accordingly, the last bit 1008 of the four bits 1010 representing possible values for “classification” has a value of “1.” Because the message contains no “category” property, the source context for “category” 1012 has no bits with a value of “1.” The message also contains a header 1014 and a message body 1016, which contains the rest of the information contained in the message.

When this message is evaluated, the decision engine first evaluates it against the first rule, which states that a message is released if “classification” is less than “secret.” The decision engine looks up the binary encoding “0001” of the opcode for this first rule and translates it as a mathematical “<” operation. In this case, the source context for “classification” in the message is “unclassified,” which is encoded as 00000001. The corresponding rule context for the first rule corresponds to “Secret,” which is encoded as 00000100. When the decision engine evaluates “00000001<00000100,” the result is “true,” so the message is released. No further rules need to be evaluated because the first rule was satisfied.

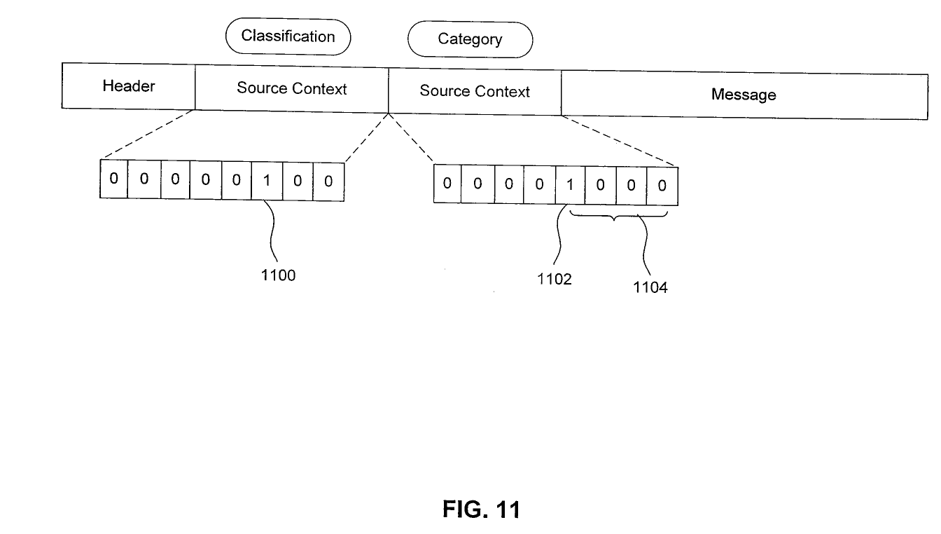

FIG. 11 illustrates an example of an encoded message with two properties: a “classification” of “Secret” and a “category” of “Purple.” In this example, the corresponding bit for secret 1100 has a value for “1” in the first rule context (corresponding to “classification”). The second rule context corresponds to “category,” which has four possible values defined in the grammar. In this case, “Purple” is the first possible value, so the first bit 1102 of the four bits 1104 representing possible values for “category” has a value of “1.”

When this message is evaluated, the decision engine first determines if the properties of the message satisfy the first rule, which states that a message is released if “classification” is less than “secret.” In this case, the “classification” property of the message is “Secret,” which is encoded as 00000100. When the decision engine evaluates “00000100<00000100,” the result is “false.”

The decision engine then evaluates the message against the second rule, which states that a message is released if “classification” equals “Secret” and “category” is contained by the set “Purple” and “Magic.” The decision engine looks up the binary encoding “0011” of the opcode for the first clause of the second rule and translates it as a mathematical “=.” The decision engine next evaluates the source context for “classification” in the message against the rule context for “classification” in the rule. The operation “00000100=00000100” results in a value of “true.”

The decision engine next evaluates the second clause of the second rule, which states that “category” must be contained by the set “Purple” and “Magic.” The decision engine looks up the binary encoding “0101” of the opcode for the second clause of the second rule, which translates to a bitwise OR operation combined with a test of equality to the rule context. In this case, the message has a “category” of purple, which is encoded as 00001000. The corresponding rule context of the set “Purple” and “Magic” is encoded as “00001100.” The decision engine evaluates “(0000100 OR 00001100)=00001100,” resulting in “true” because (0000100 OR 00001100) results in 00001100. Because both clauses of the second rule are satisfied, the message is released.

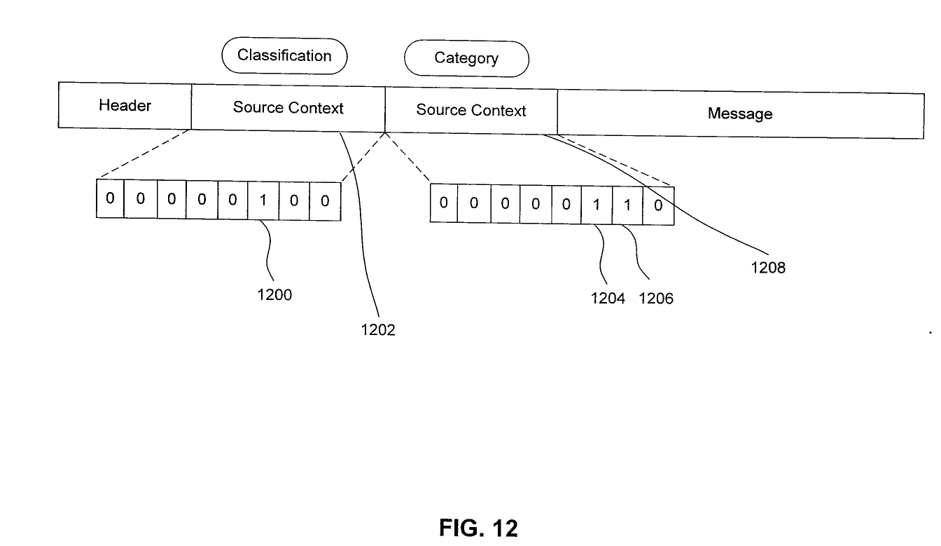

FIG. 12 illustrates an example of an encoded message with a “classification” of “Secret” and a “category” of “Soda” and “Magic.” Accordingly, the bit for “Secret” 1200 in the first source context 1202 has a value of “1,” and the bits for “Magic” 1204 and “Soda” 1206 in the second source context 1208 also have a value of “1.”

When this message is evaluated, the decision engine first evaluates the source context of the first property of the message against the corresponding rule context for the first rule. In this case, the message has a “classification” of “Secret,” and it is not true that “00000100<00000100,” so the decision engine evaluates the second rule.

The second rule states that “classification” must be “Secret” and that “category” must be a subset of “Purple” and “Magic.” The message has a “classification” of “Secret,” so “00000100=00000100” evaluates as true. However, the message has “categories” of “Soda” and “Magic,” encoded as 00000110, which are not contained by the subset “Purple” and “Magic,” encoded as 00001100. The decision engine evaluates “(00000110 OR 00001100)=00001100,” which evaluates as false because (00000110 OR 00001100) results in 00001110. Because the message properties do not satisfy either rule and there are no more rules to evaluate, the message is dropped.

The above examples illustrate how otherwise inefficient comparison between arbitrary strings can be reduced to highly efficient mathematical operations by encoding the property values in messages and rules into binary representations and encoding the rule operations into an index of a table of mathematical operations.

### 4. Applications

The method, system, and apparatus described herein are useful for cross domain applications where decisions must be made regarding releasability of the message and in other environments where messages might be blocked or routed differently based on their characteristics.

For example, in a command and control scenario, messages may contain troop movement orders or updated current troop positions. The system disclosed herein is able to process thousands of messages per second and is especially useful for situations where the timeliness of message evaluation is critical.

### 5. Conclusion

The above system and process may be implemented as a computer program executing on a machine, as a computer program product, or as a computer-readable medium.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
receiving, at a message routing device, a message from a first server, the message having a property and a value;
determining, using the message routing device, a grammar, and a policy, that the property and value are to be evaluated,
wherein the policy comprises a rule, and
wherein the rule comprises a rule property and a rule value;
encoding, using the message routing device and a properties encoding mechanism, the message into a binary representation of the message;
encoding, using the message routing device and a policy compiler, the policy into a binary representation of the policy,
evaluating, using the message routing device and a decision engine, the property and value by performing a bitwise comparison of the encoded property and value with the encoded rule property and rule value;
determining, using the message routing device and based on the evaluated property and value, whether the message should be sent to a second server; and
if it is determined that the message should be sent, sending the message, using the message routing device, to the second server.

2. The method of claim 1, wherein the message is generated upon the occurrence of an event.

3. The method of claim 1, wherein the binary representation of the message and binary representation of the policy have a fixed length.

4. The method of claim 1, wherein the message is a Java Message System (JMS) message.

5. The method of claim 1, wherein the message is denied release unless specifically permitted by the release policy.

6. The method of claim 1, wherein the grammar and the policy are specified by an administrator of the message routing device.

7. The method of claim 6, wherein the policy comprises logical operators.

8. The method of claim 1, wherein the message contains troop movement orders or updated current troop positions.

9. The method of claim 1, wherein the policy corresponds to a level of trust of a network.

10. The method of claim 1, wherein the binary representation of the policy comprises a header, a binary representation of a logical operator, and a binary representation of the rule value.

11. The method of claim 1, wherein the binary representation of the message comprises a header, a binary representation of the value, and a binary representation of message content.

12. A message routing system comprising:
a first server configured to send messages to and receive messages from a first network;
a second server configured to send messages to and receive messages from a second network; and
a message router configured to:
determine, based on a grammar specifying a plurality of properties to be evaluated and a policy, a property and value in a received message to be evaluated;
encode the message into a binary representation of the message;
encode a configurable policy specifying a rule property and a rule value that must be present in a message for a message to be sent;
determine whether a message should be sent from the first server to the second server or from the second server to the first server based on comparing the encoded property and value with the encoded rule property and rule value; and
if it is determined that the message should be sent, send the message.

13. The system of claim 12, wherein the first server and the second server comprise offload engines.

14. The system of claim 12, wherein the first server and the second server comprise a front end and a back end.

15. The system of claim 12, wherein the message router uses a separate release policy for each direction of message flow.

16. The system of claim 12, further comprising a routing configuration specifying a mapping between input resources and output resources.

17. The system of claim 12, wherein the routing configuration does not override the release policy.

18. The system of claim 12, wherein the first network and the second network are physically and logically separate.

19. The system of claim 12, wherein the first network and the second network each represents a distinct security domain with differing confidentiality and integrity properties.

20. The system of claim 12, wherein the flow of messages through the system is bidirectional.

21. The system of claim 12, wherein the system comprises a secure blade system containing three separate sub-systems, each with its own CPU, memory, hard drives, and network cards.

22. A message routing system comprising:
a grammar module specifying a property and value to be evaluated, a policy module specifying a policy comprising a rule property and a rule value;
a properties encoding mechanism configured to encode the property and value;
a policy compiler configured to encode the policy; and
a decision engine configured to perform a bitwise comparison, using a processing device, between the encoded property and value with the encoded rule property and rule value.

23. A method comprising:
defining, using a rules language and a processing device, a grammar and message semantics; and
defining, using the rules language and the processing device, a policy specifying conditions for a message to be sent,
wherein the conditions comprise a rule specifying a rule property and a rule value to be encoded and, using a bitwise comparison, evaluated against an encoded property and value of the message.
